(19) United States
(12) Patent Application Publication
(10) Pub. No.: US 2009/0270573 A1
(43) Pub. Date: Oct. 29, 2009

(54) Process for coagulating perfluoroelastomers

(76) Inventor: Christopher John BISH, Kennett Square, PA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/150,521

(22) Filed: Apr. 29, 2008

(51) Int. Cl. C08F 14/26

(52) U.S. Cl. 526/247

(57) ABSTRACT

In a process for the manufacture of perfluoroelastomers, a weak organic acid, e.g. glacial acetic acid, is employed to coagulate an acidic perfluoroelastomer dispersion.

### FIELD OF THE INVENTION

This invention pertains to a novel process for the coagulation of perfluoroelastomers wherein a weak organic acid is employed as the coagulating agent in order to coagulate an acidic perfluoroelastomer dispersion.

### BACKGROUND OF THE INVENTION

Elastomeric copolymers of tetrafluoroethylene and a perfluoro(alkyl vinyl ether), preferably perfluoro(methyl vinyl ether), having excellent heat resistance and chemical resistance have been used widely for sealing materials.

Production of such perfluoroelastomers by emulsion polymerization methods is well known in the art; see for example U.S. Pat. Nos. 4,281,092 and 5,789,489. The result of the polymerization is a dispersion or latex of the copolymer. Generally, perfluoroelastomers are then separated from the dispersion by addition of a coagulant to form a slurry. The slurry is then washed and dried and then shaped into final form and vulcanized.

Coagulants heretofore employed are typically salts of inorganic multivalent cations, A. L. Logothetis, Prog. Polym. Sci, 14, 251-296 (1989). These include aluminum salts such as aluminum sulfate, alums such as potassium aluminum sulfate, calcium salts such as calcium chloride and calcium nitrate, and magnesium salts such as magnesium chloride and magnesium nitrate. While these salts work very well as coagulants, residual amounts of these salts remain in the polymer. The presence of these salts renders these polymers unsuitable for use in contamination-sensitive applications such as seals in semiconductor manufacture. Thus, it would be desirable to find other coagulants effective for use in isolation perfluoroelastomers.

Salts of univalent cations, such as sodium chloride, have been proposed as coagulating agents for the manufacture of perfluoroelastomers. Residual amounts of these salts are considered relatively innocuous in some end use applications, but not in others (e.g. semicon) present problems. Also, excessively large amounts of salts of univalent cations are required to fully coagulate the perfluoroelastomer, resulting in the requirement of large and expensive water treatment facilities.

Strong-acids, both inorganic (e.g. nitric acid) and organic (e.g. trifluoroacetic acid) have been employed as coagulants for perfluoroelastomers and fluoroelastomers (U.S. Pat. No. 6,703,461 B1). Due to the corrosive nature of the strong acids, storage, handling and neutralization can be costly.

Perfluoroelastomers have also been coagulated with organo onium compounds (US 2005/0143523). However, the presence of residual organo onium compounds in the resulting elastomer gum can cause premature vulcanization (i.e. scorch), making processing difficult.

### SUMMARY OF THE INVENTION

Surprisingly, it has been found that certain weak organic acids (i.e. pKa between 3.5 and 5) may be used to coagulate perfluoroelastomers without resulting in a gel and without causing the elastomers to cure prematurely. One aspect of the present invention provides a coagulation process for the production of perfluoroelastomers, said process comprising:

(A) providing an aqueous dispersion comprising a perfluoroelastomer, said perfluoroelastomer comprising copolymerized units of tetrafluoroethylene, 15 to 65 mole percent of a perfluoro(alkyl vinyl ether) and 0.1 to 5 mole percent of a cure site monomer, said dispersion having 1.5<pH<7; and

(B) adding to said aqueous dispersion an organic acid having a pKa between 3.5 and 5 thereby coagulating said perfluoroelastomer.

### DETAILED DESCRIPTION OF THE INVENTION

The present invention is directed to a coagulation process for producing a perfluoroelastomer gum or crumb. By “perfluoroelastomer” is meant an amorphous elastomeric perfluoropolymer. Perfluoroelastomers that may be employed in the process of this invention contain copolymerized units of tetrafluoroethylene (TFE), 15 to 65 (preferably 25 to 60) mole percent of a perfluoro(alkyl vinyl ether) and 0.1 to 5 (preferably 0.3 to 1.5) mole percent of a cure site monomer, wherein the total mole percent of copolymerized monomers is 100.

Perfluoro(alkyl vinyl) ethers (PAVE) suitable for use as monomers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl) ether (PMVE) and perfluoro(propyl vinyl) ether (PPVE). PMVE is most preferred.

Other useful PAVE monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluoro(alkyl vinyl) ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

The perfluoroelastomers employed in the coagulation process of the present invention also comprise copolymerized units of one or more cure site monomers. Examples of suitable cure site monomers include: i) bromine-containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) and perfluoro(2-phenoxypropyl vinyl) ether.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroalkyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂ (R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH-Z-CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂OCF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1 (ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Useful nitrile-containing cure site monomers include those of the formulas shown below.

CF₂═CF—O(CF₂)ₙ—CN (VI)

where n=2-12, preferably 2-6;

CF₂═CF—O[CF₂—CF(CF₃)—O]ₙ—CF₂—CF(CF₃)—CN (VII)

where n=0-4, preferably 0-2;

CF₂═CF—[OCF₂CF(CF₃)]ₓ—O—(CF₂)ₙ—CN (VIII)

where x=1-2, and n=1-4; and

CF₂═CF—O—(CF₂)ₙ—O—CF(CF₃)CN (IX)

where n=2-4. Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (X)

i.e. perfluoro(8-cyano-5-methyl-3,6-dioxa-1-octene) or 8-CNVE. Nitrile-containing cure site monomers are particularly useful in copolymers also containing tetrafluoroethylene and perfluoro(methyl vinyl ether).

Of the cure site monomers listed above, preferred compounds, for situations wherein the perfluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; bromotrifluoroethylene and 8-CNVE. When the perfluoroelastomer will be cured with a polyol, 2-HPFP or perfluoro(2-phenoxypropyl vinyl) ether is the preferred cure site monomer. When the perfluoroelastomer will be cured with a tetraamine, bis(aminophenol), bis(thioaminophenol), or a compound that liberates ammonia during curing (e.g. urea), 8-CNVE is the preferred cure site monomer.

Additionally, iodine-containing endgroups, bromine-containing endgroups or mixtures thereof may optionally be present at one or both of the perfluoroelastomer polymer chain ends as a result of the use of chain transfer or molecular weight regulating agents during preparation of the perfluoroelastomers. The amount of chain transfer agent, when employed, is calculated to result in an iodine or bromine level in the perfluoroelastomer in the range of 0.005-5 wt. %, preferably 0.05-3 wt. %, based on total weight of said perfluoroelastomer.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use in the process of this invention include those disclosed in U.S. Pat. No. 3,707,529. Examples of such agents include isopropanol, diethylmalonate, ethyl acetate, carbon tetrachloride, acetone and dodecyl mercaptan.

Cure site monomers and chain transfer agents may be added to the reactor neat or as solutions. In addition to being introduced into the reactor near the beginning of polymerization, quantities of chain transfer agent may be added throughout the entire polymerization reaction period, depending upon the desired composition of the perfluoroelastomer being produced, the chain transfer agent being employed, and the total reaction time.

Perfluoroelastomers that may be employed in the coagulation process of this invention are typically made in an emulsion polymerization process that may be a continuous, semi-batch or batch process.

In a semi-batch emulsion polymerization process, a gaseous monomer mixture of a desired composition (initial monomer charge) is introduced into a reactor which contains an aqueous solution. The aqueous solution may optionally contain a surfactant. The reactor is typically not completely filled with the aqueous solution, so that a vapor space remains. Optionally, the aqueous solution may contain a pH buffer, such as a phosphate or acetate buffer for controlling the pH of the polymerization reaction. Instead of a buffer, a base, such as NaOH may be used to control pH. Generally, pH is controlled to between 2 and 6, depending upon the type of perfluoroelastomer being prepared. Alternatively, or additionally, pH buffer or base may be added to the reactor at various times throughout the polymerization reaction, either alone or in combination with other ingredients such as polymerization initiator, liquid cure site monomer, additional surfactant or chain transfer agent. Also optionally, the initial aqueous solution may contain a water-soluble inorganic peroxide polymerization initiator. In addition, the initial aqueous solution may contain a nucleating agent, such as a perfluoroelastomer seed polymer prepared previously, in order to promote perfluoroelastomer latex particle formation and thus speed up the polymerization process.

The initial monomer charge contains a quantity of tetrafluoroethylene and a perfluoroalkyl(vinyl ether), preferably perfluoro(methyl vinyl ether). The amount of monomer mixture contained in the initial charge is set so as to result in a reactor pressure between 0.5 and 10 MPa.

The monomer mixture is dispersed in the aqueous medium and, optionally, a chain transfer agent may also be added at this point while the reaction mixture is agitated, typically by mechanical stirring. In the initial gaseous monomer charge, the relative amount of each monomer is dictated by reaction kinetics and is set so as to result in a perfluoroelastomer having the desired ratio of copolymerized monomer units (i.e. very slow reacting monomers such as PMVE must be present in a higher amount relative to the other monomers than is desired in the composition of the perfluoroelastomer to be produced).

The temperature of the semi-batch reaction mixture is maintained in the range of 25° C.-130° C., preferably 50° C.-120° C. Polymerization begins when the initiator either thermally decomposes or reacts with reducing agent and the resulting radicals react with dispersed monomer.

Additional quantities of the gaseous monomers and cure site monomer (incremental feed) are added at a controlled rate throughout the polymerization in order to maintain a constant reactor pressure at a controlled temperature. The relative ratio of monomers contained in the incremental feed is set to be approximately the same as the desired ratio of copolymerized monomer units in the resulting perfluoroelastomer. Chain transfer agent may also, optionally, be introduced into the reactor at any point during this stage of the polymerization. Typically, additional polymerization initiator is also fed to the reactor during this stage of polymerization. The amount of copolymer formed is approximately equal to the cumulative amount of incremental monomer feed. One skilled in the art will recognize that the molar ratio of monomers in the incremental feed is not necessarily exactly the same as that of the desired (i.e. selected) copolymerized monomer unit composition in the resulting perfluoroelastomer because the composition of the initial charge may not be exactly that required for the selected final perfluoroelastomer composition, or because a portion of the monomers in the incremental feed may dissolve into the polymer particles already formed, without reacting. Polymerization times in the range of from 2 to 30 hours are typically employed in this semi-batch polymerization process.

A continuous emulsion polymerization process for manufacture of perfluoroelastomers differs from the semi-batch process in the following manner. The reactor is completely filled with aqueous solution so that there is no vapor space. Gaseous monomers and solutions of other ingredients such as water-soluble monomers, chain transfer agents, buffer, bases, polymerization initiator, surfactant, etc., are fed to the reactor in separate streams at a constant rate. Feed rates are controlled so that the average copolymer residence time in the reactor is generally between 0.2 to 4 hours. Short residence times are employed for reactive monomers, whereas less reactive monomers such as perfluoro(alkyl vinyl) ethers require more time. The temperature of the continuous process reaction mixture is maintained in the range of 25° C.-130° C., preferably 80° C.-120° C.

The polymerization pressure is controlled in the range of 0.5 to 10 MPa, preferably 1 to 6.2 MPa. In a semi-batch process, the desired polymerization pressure is initially achieved by adjusting the amount of gaseous monomers in the initial charge, and after the reaction is initiated, the pressure is adjusted by controlling the incremental gaseous monomer feed. In a continuous process, pressure is adjusted by a back-pressure regulator in the dispersion effluent line. The polymerization pressure is set in the above range because if it is below 1 MPa, the monomer concentration in the polymerization reaction system is too low to obtain a satisfactory reaction rate. In addition, the molecular weight does not increase sufficiently. If the pressure is above 10 MPa, the cost of the required high pressure equipment is very high.

The amount of perfluoroelastomer copolymer formed is approximately equal to the amount of incremental feed charged, and is in the range of 10-30 parts by weight of copolymer per 100 parts by weight of aqueous medium, preferably in the range of 20-25 parts by weight of the copolymer. The degree of copolymer formation is set in the above range because if it is less than 10 parts by weight, productivity is undesirably low, while if it is above 30 parts by weight, the solids content becomes too high for satisfactory stirring. The pH of the resulting perfluoroelastomer dispersion is greater than 1.5 and less than 7, preferably between 2 and 6, most preferably between 4 and 6.

Water-soluble peroxides which may be used to initiate polymerization in this invention include, for example, the ammonium, sodium or potassium salts of hydrogen persulfate. In a redox-type initiation, a reducing agent such as sodium sulfite, is present in addition to the peroxide. These water-soluble peroxides may be used alone or as a mixture of two or more types. The amount to be used is selected generally in the range of 0.01 to 0.4 parts by weight per 100 parts by weight of copolymer, preferably 0.05 to 0.3. During polymerization some of the fluoroelastomer polymer chain ends are capped with fragments generated by the decomposition of these peroxides.

Surfactants, typically anionic surfactants, are optionally employed in these processes. Examples of surfactants include, but are not limited to perfluorooctanoic acid (and its salts), sodium octyl sulfonate, and perfluorohexylethylsulfonic acid (and its salts). However, surfactant is not necessarily required.

Perfluoroelastomer gum or crumb is coagulated in the acidic perfluoroelastomer dispersions by the addition of a weak (pKa between 3.5 and 5) organic acid to the dispersion. Examples of weak organic acids include, but are not limited to glacial acetic acid, propionic acid, formic acid and butyric acid. The acid may be added neat, or as an aqueous solution, to the perfluoroelastomer dispersion.

Optionally, coagulated perfluoroelastomer may be isolated from the aqueous medium by conventional means including, but not limited to filtering, centrifuging, or decanting. The resulting perfluoroelastomer may, optionally, be washed with deionized water, preferably until such time that the conductance of the water exiting the perfluoroelastomer is less than 100 (more preferably less than 50) μS.

Optionally, residual coagulant may be removed from perfluoroelastomer by heating the perfluoroelastomer to sufficient temperature to volatilize the coagulant, preferably to a temperature between 70° and 300° C., most preferably 800 to 110° C.

The perfluoroelastomers prepared by the process of this invention are useful in many industrial applications including seals, tubing and laminates.

### EXAMPLES

The invention is further illustrated by, but is not limited to, the following examples.

### Example 1

A terpolymer containing copolymerized units of 61.7 mol % tetrafluoroethylene (TFE), 37.5 mol % perfluoro(methyl vinyl)ether (PMVE) and 0.8 mol % 8-CNVE was prepared in the following manner. Three separate aqueous solutions were fed simultaneously to a 5.575 liter mechanically stirred, water-jacketed, stainless steel autoclave, each at a rate of 688 ml/hour. Solution A contained 26.1 g ammonium persulfate, 686.8 g disodium hydrogen phosphate, and 600 g of ammonium perfluorooctanoate dissolved in 20 liters of de-ionized water. Solution B contained 600 g of ammonium perfluorooctanoate dissolved in 20 liters of de-ionized water and Solution C contained 26.1 g ammonium persulfate, and 600 g ammonium perfluorooctanoate dissolved in 20 liter de-ionized water. At the same time, the liquid monomer perfluoro-(8-cyano-5-methyl-3,6-dioxa-1-octene) (8-CNVE) was fed at the rate of 19.1 g/hour. By means of a diaphragm compressor, a gaseous mixture of tetrafluoroethylene (TFE) (320.9 g/hour) and perfluoro(methyl vinyl) ether (PMVE) (377.4 g/hour) was fed to the reactor at a constant rate. The temperature of the reaction was maintained at 85° C., and the pressure at 4.1 MPa (600 psi). The polymer emulsion was removed continuously by means of a let-down valve, and the unreacted monomers were vented. A water-based silicone defoamer, type D65 available from Dow Corning Corporation, Midland, Mich., was added continuously at the minimum rate necessary to prevent foaming of the emulsion while the gases were vented.

1000 g of the above perfluoroelastomer dispersion was coagulated by slow addition to 1 L (1050 g) of glacial acetic acid while stirring with an IKA Labortechnik Ultra Turrax T50 (available from Janke and Kunkel). Additional glacial acetic acid was added, while stirring continued, until a total of about 1670 g glacial acetic had been introduced to the perfluoroelastomer dispersion. The supernatant became cloudy during coagulation. The coagulated perfluoroelastomer was filtered and then washed with deionized water until the conductance of water that had flowed through the perfluoroelastomer had reached 38 μS. The resulting copolymer was dried in a circulating air oven at 100° C. for about 16 hours. Yield from the coagulation process was 87.8%.

Perfluoroelastomer metals content was determined by inductively coupled plasma (ICP). The average metal content in two perfluoroelastomer samples, one prepared in the above process and the other prepared in a scaled down version of the above process, was Ba, Cr, Cu, Mn, Ni, Pb, Ti, V, Sn, Co, Sb, Mo, and Cd<1 ppm; Ca 11 ppm; Zn 8 ppm; Al 5 ppm; and Si, Mg 3 ppm. Residual Na from the disodium phosphate buffer employed during polymerization was not completely washed from the perfluoroelastomer samples, resulting in Na of 548 ppm in one sample and 32 ppm in the other sample.

What is claimed is:

1. A coagulation process for the production of perfluoroelastomers, said process comprising:
(A) providing an aqueous dispersion comprising a perfluoroelastomer, said perfluoroelastomer comprising copolymerized units of tetrafluoroethylene, 15 to 65 mole percent of a perfluoro(alkyl vinyl ether) and 0.1 to 5 mole percent of a cure site monomer, said dispersion having a 1.5<pH<7; and
(B) adding to said aqueous dispersion an organic acid having a pKa between 3.5 and 5 thereby coagulating said perfluoroelastomer.

2. A coagulation process of claim 1 wherein said perfluoro(alkyl vinyl ether) is perfluoro(methyl vinyl ether).

3. A coagulation process of claim 2 wherein said cure site monomer is a nitrile-containing cure site monomer.

4. A coagulation process of claim 1 wherein said perfluoroelastomer comprises copolymerized units of tetrafluoroethylene, 25 to 60 mole percent of a perfluoro(alkyl vinyl ether) and 0.3 to 1.5 mole percent of a cure site monomer.

5. A coagulation process of claim 1 wherein said aqueous dispersion has a pH between 2 and 5.

6. A coagulation process of claim 1 further comprising isolating said coagulated perfluoroelastomer from said dispersion and washing said coagulated perfluoroelastomer with deionized water until conductance measured on water passed through said coagulated perfluoroelastomer is less than 50 μS.

7. A coagulation process of claim 6 further comprising heating said washed, coagulated perfluoroelastomer to a temperature between 70° and 300° C. in order to volatilize organic acid contained therein.
